(19) United States
(12) Patent Application Publication
(10) Pub. No.: US 2015/0309818 A1
(43) Pub. Date: Oct. 29, 2015

(54) METHOD OF VIRTUAL MACHINE MIGRATION USING SOFTWARE DEFINED NETWORKING

(71) Applicant: NATIONAL APPLIED RESEARCH LABORATORIES, TAIPEI CITY (TW)

(72) Inventors: HUI-LAN LEE, HSINCHU CITY (TW); TE-LUNG LIU, HSIINCHU CITY (TW); JEN-WEI HU, HSIINCHU CITY (TW); MING CHEN, HSINCHU CITY (TW)

(21) Appl. No.: 14/333,764

(22) Filed: Jul. 17, 2014

(30) Foreign Application Priority Data
Apr. 24, 2014 (TW) 103114860

(51) Int. Cl. G06F 9/455

(52) U.S. Cl. CPC G06F 9/45533

(57) ABSTRACT

The present invention relates to a method of virtual machine migration, which uses the protocol of the software defined networking technology. When a virtual machine is migrated across domains, the local controller will be notified rapidly for submitting the information of the virtual machine to the switch in advance. Thereby, without modifying the network configuration, the migrated virtual machine can provide service continuously; the optimal routing is achieved and thus improving the problem of triangle routing effectively.

### FIELD OF THE INVENTION

The present invention relates generally to a method of virtual machine migration, and particularly to a method of virtual machine migration in which the service is uninterrupted and the migration is cross-site and cross-domain.

### BACKGROUND OF THE INVENTION

As technologies evolve and people's demands on networks increase, network applications such as cloud services, virtual technologies, and big data emerge. These network applications require a substantial amount of network resources, excellent bandwidth management, and a security policy. The requirements are not easily implemented in the current distributed network architecture. As the network topology expands, it becomes more difficult to manage the network effectively. In order to solve these important problems, the concept and technology of software defined networking (SDN) are proposed, valued, and researched extensively in recent years accordingly.

As the cloud computing is developing rapidly, the demand for services of cloud application rises sharply. For increasing the reliability of cloud services, the demand for virtual machine migration emerges. In particular, in order to ensure uninterrupted cloud services, the primary challenge is the network problem in cross-domain migration of virtual machines.

Please refer to FIG. 1, which shows a schematic diagram of packet path according to the prior art. As shown in the figure, the first domain 10 and the second domain 11 are different. The second virtual machine (VM2) 12 operates firstly in the first domain 10. After it is migrated to the second domain 11, its original IP configuration is maintained. Because the second virtual machine 12 and the third virtual machine 13 have IP addresses belonging to different domains, respectively, when the third virtual machine 13 communicates with the migrated second virtual machine 12, packets enter the Internet via the gateway router of the third virtual machine 13. After looking up the routing table in the Internet, the packets are transmitted to the entrance router of the first domain 10, and then to the Layer 2 switch connected therein. In the architecture, there is a tunnel between the aggregation layer switches 14A, 14B, so that the access layer switch 16A and the aggregation layer switch 14A of the first domain 10 and the access layer switch 16B and the aggregation layer switch 14B of the second domain 11 all belong to the same Layer 2 broadcast domain. Thereby, the packets will be transmitted from the aggregation layer switch 14A, passing through the tunnel 15, and the access layer switch 16B and the aggregation layer switch 14B of the second domain 11, and finally to the destination.

The path described above is called triangle routing. This asymmetric path results in prominent and extra burdens in communication delay and waste in network resources. In particular, for data centers, the flow direction is mainly lateral, which further exhibits inefficiency owing to the delay of packet transmission.

The China patent application number CN 201210567450.X disclosed “Method of Migration Processing in Network Control Strategy of Virtual Machine and System Thereof”, which acknowledges that a virtual machine has been migrated from one site to another according to the alteration of port connected to switches before and after migration. The patent application monitors the information of virtual machine migration and modifies the rules of data forwarding for virtual switches. Thereby, when a virtual machine is migrated to a different physical host, its corresponding network strategy can be maintained, and thus providing continuous and consistent network control services for virtual machines.

In addition, the US patent publication number US 20130151661 disclosed a technology for virtual machine migration, which uses the technology of network address translation (NAT) to process virtual machine migration. According to the patent application, when a virtual machine is migrated form a first host to a second host, an NAT message is transmitted automatically to the second host. Then the forward management unit operating in the second host can process the immigrating virtual machine according to the NAT message.

### SUMMARY

An objective of the present invention is to provide a method of virtual machine migration using SDN. While performing cross-domain migration of a virtual machine, by using the SDN technology, the network controller can be notified rapidly and then send the forward flow table of the virtual machine to the switch in advance, According to the present method, after the virtual machine is migrated, it is not necessary to modify the network configuration and services continue. Thereby, the optimal routing can be achieved and the problem of triangle routing can be improved effectively.

Another objective of the present invention is to provide a method of virtual machine migration using SDN. The adopted technology is SDN. In the architecture, separate controller and switch communicate with each other for achieving the optimal routing. Those methods modifying the flow table of a switch via an open or closed interface are all within the scope of the SDN according to the present invention.

Still another objective of the present invention is to provide a method of virtual machine migration using SDN. It can be applied to cross-domain cloud data center, agent program for notifying virtual machine migration, supporting application programs of network controller for cross-domain virtual machine migration, or supporting SDN network switches for cross-domain virtual machine migration. Thereby, the present invention has commercial values.

In order to achieve the objectives described above, the present invention discloses a method of virtual machine migration using SDN. When a virtual machine of a first host in a first domain is migrated to a second domain, the following steps are executed. The virtual machine or the first host provides a first migration notice to a first controller of the first domain, and the virtual machine or a second host also provides a second migration notice to a second controller of the second domain. The first and second migration notices at least comprises the IP address, the MAC address, and the gateway address of the virtual machine, respectively. Then the second control writes a flow entry to a switch of the second domain, so that a packet with the destination of the virtual machine via a router of the second domain is forwarded to a second host of the second domain to which the virtual machine is migrated, and the packet transmitted to the second domain by the virtual machine is forwarded to the second controller for processing. According to the steps of the present method, cross-site and cross-domain migration of virtual machine can be accomplished effectively without interrupting services.

### BRIEF DESCRIPTION OF THE DRAWINGS

FIG. 1 shows the triangle routing problem unfavorable for packet transmission occurred after migration of a virtual machine according to the prior art;

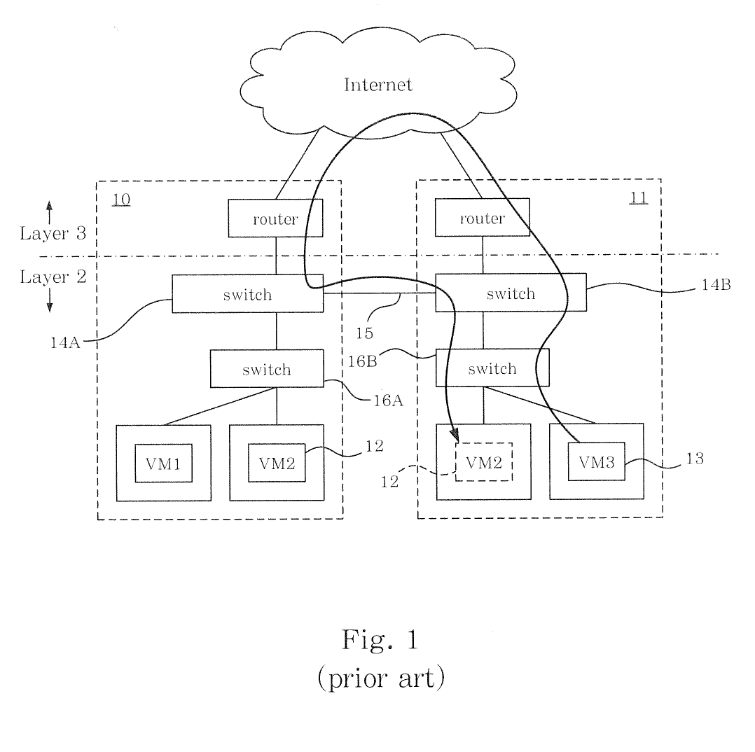

FIG. 2 shows a flowchart according to a preferred embodiment of the present invention;

FIG. 3 shows a schematic diagram of the device architecture of the second domain to which the virtual machine migrates according to a preferred embodiment of the present invention;

FIG. 4 shows a schematic diagram in which the second controller receives the migration notice and writes the flow entry to the flow table of the Layer 2 switch according to a preferred embodiment of the present invention;

FIG. 5 shows a schematic diagram of the packet transmission path and the device architecture when communication occurs between another virtual machine located in the second domain and the virtual machine migrated to the second domain according a preferred embodiment of the present invention;

FIG. 6 shows a schematic diagram of packet transmission path according to the flow entry 1 according to a preferred embodiment of the present invention;

FIG. 7 shows a schematic diagram of packet transmission path according to the flow entry 3 and 4 according to a preferred embodiment of the present invention; and

FIG. 8 shows a schematic diagram of the packet transmission path and the device architecture when communication occurs between the virtual machine migrated to the second domain and another virtual machine located in the first domain according a preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

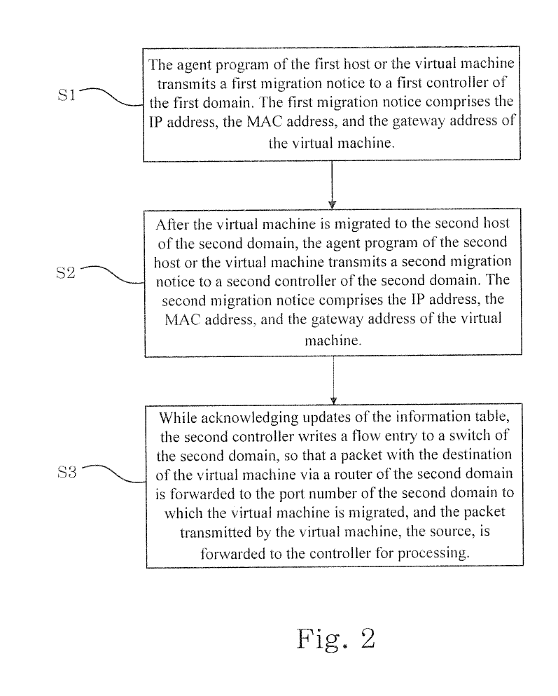

First, please refer to FIG. 2, which shows a flowchart according to a preferred embodiment of the present invention. When a virtual machine of a first host in a first domain is migrated to a second domain, the following steps are executed.

Step 1: The agent program of the first host or the virtual machine transmits a first migration notice to a first controller of the first domain. The first migration notice comprises the IP address, the MAC address, and the gateway address of the virtual machine.

Step 2: After the virtual machine is migrated to a second host of the second domain, the agent program of the second host or the virtual machine transmits a second migration notice to a second controller of the second domain. The second migration notice comprises the IP address, the MAC address, and the gateway address of the virtual machine.

Step 3: While acknowledging updates of the information table, the second controller writes a flow entry to a switch of the second domain, so that a packet with the destination of the virtual machine via a router of the second domain is forwarded to the port of the second domain to which the virtual machine is migrated, and the packet transmitted by the virtual machine, the source, is forwarded to the controller for processing.

The agent program of the first host described above and the agent program of the second host described above are installed in the first host and the second host, respectively.

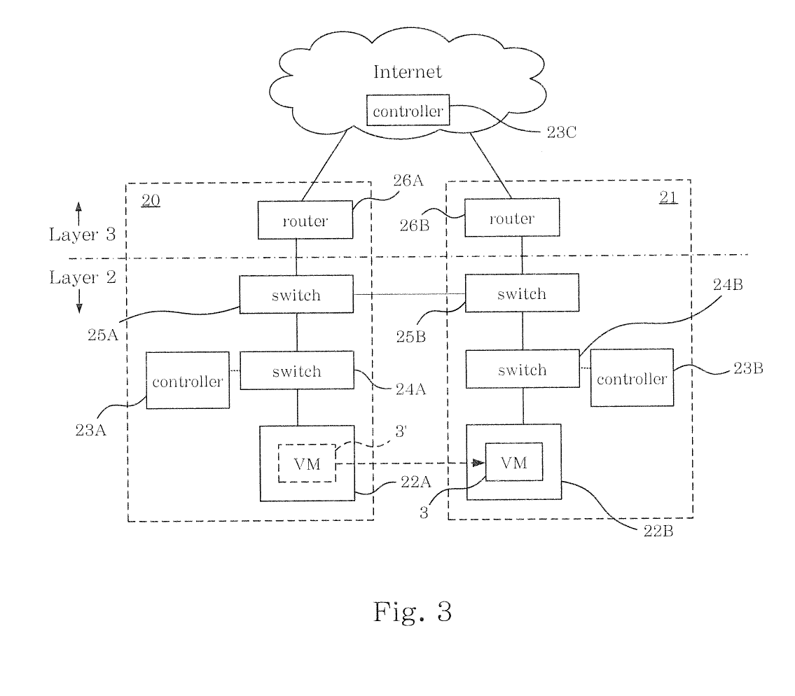

Please refer to FIG. 3, which shows a schematic diagram of the device architecture. As shown in the figure, when the above preferred embodiment is operating, the device architecture is distributed to the first domain 20 and the second domain 21. The devices comprises the first host 22A, the second host 22B, the first controller 23A, the second controller 23B, the central controller 23C, the first access layer switch 24A, the first aggregation layer switch 25A, the second access layer switch 24B, the second aggregation layer switch 25B, the first router 26A, and the second router 26B. The first host 22A, the first controller 23A, the first access layer switch 24A, the first aggregation layer switch 258, and the first router 26A are located in the first domain 20; the second host 22B, the second controller 23B, the second access layer switch 24B, the second aggregation layer switch 25B, and the second router 26B are located in the second domain 21. The central controller 23C is located in the accessible network; it can also be installed in the same host of the area controller. For shortening the transmission delay, the first and second controllers 23A, 23B are area controllers.

In order to improve the problem of triangle routing effectively, according to the present preferred embodiment, when the virtual machine 3′ operating originally in the first host 22A is migrated to the second host 22B and becoming the virtual machine 3, the domains of the two hosts are different. They have different domains for IP address. Nonetheless, the IP address of the migrated virtual machine 3 is not altered.

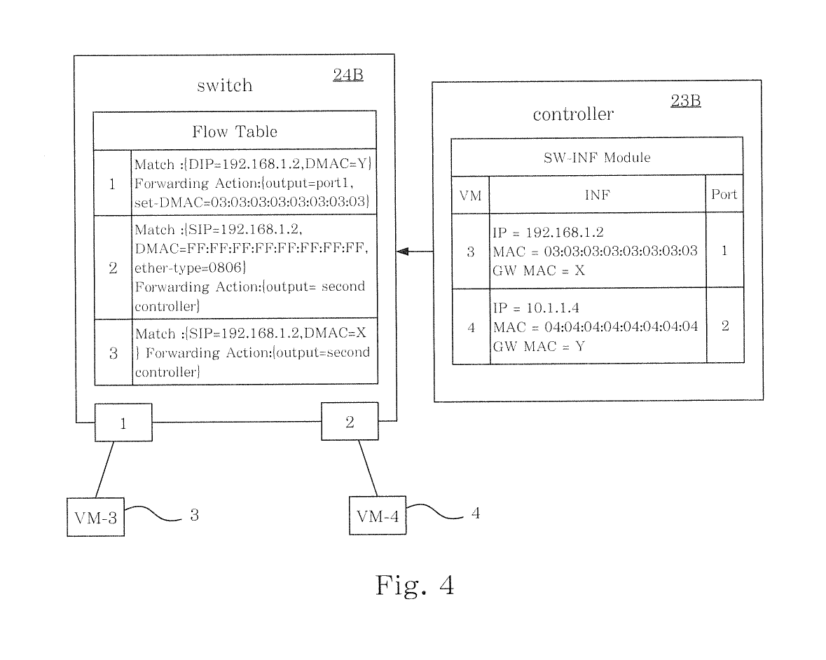

While migrating the virtual machine, the agent program of the first host 22A will provide the first migration notice to the first controller 23A for notifying that “the virtual machine 3′ is emigrating”. Alternatively, the virtual machine can provide the first migration notice to the first controller 23A; the agent program of the migrated second host 22B will provide the second migration notice to the second controller 23B for notifying that “the virtual machine 3 is immigrating”. Alternatively, the virtual machine will provide the second migration notice to the second controller 23B. The first and second migration notices described above comprises the IP address, the MAC address, and the gateway address of the virtual machine 3. Next, the second controller 23B writes a flow entry automatically to the second access layer switch 248, which is a SDN switch. The above flow entry is written automatically to the flow table of the second access layer switch 24B when the virtual machine is migrating, which enables the second domain to shorten packet transmission. The flow entry described above at least comprises a flow entry 1, a flow entry 2, and a flow entry 3, as shown in FIG. 4. The formats of the transmitted packet according to the present invention include, but not limited to, the source MAC address (S-MAC), the destination MAC address (D-MAC), the source IP address (SIP), the destination IP address (DIP), the TCP source port (TCP sport), and the PCT destination port (TCP dport).

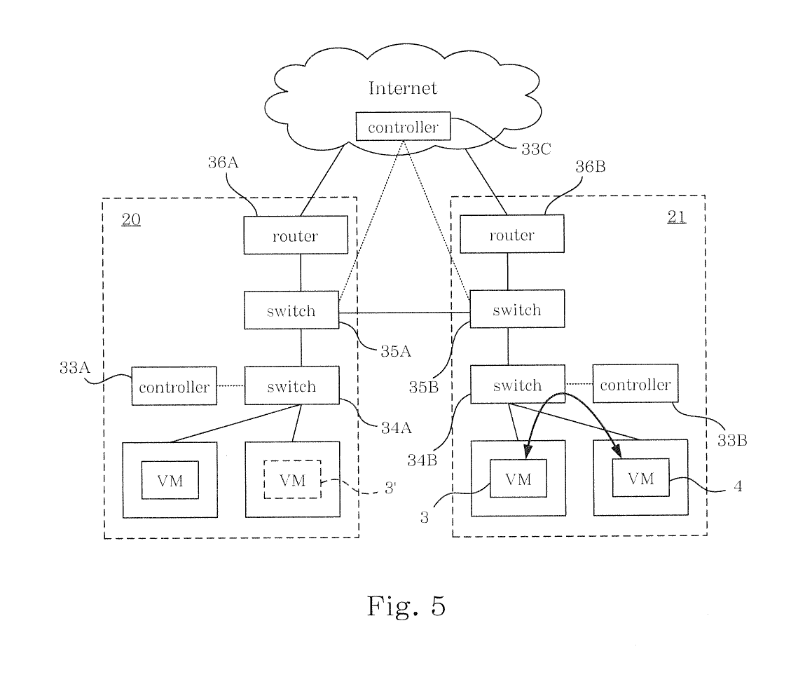

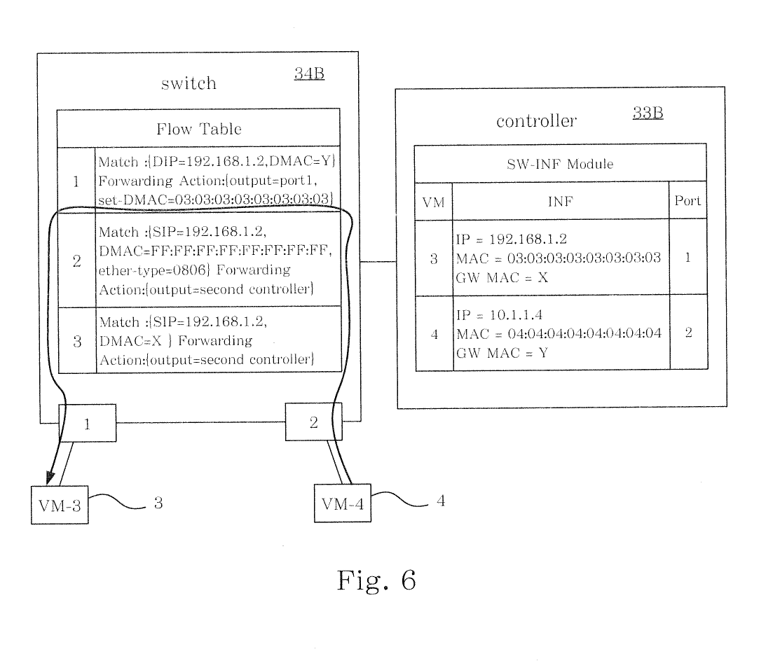

After completing migration of the virtual machine according to the above steps, please refer to FIG. 5 for the details of packet transmission according to an embodiment. When communication occurs between another virtual machine 4 located in the second domain 21 and the virtual machine 3 described above, one possibility is that the second virtual machine 4 is to transmit packets to the virtual machine 3. For this circumstance, please also refer to FIG. 6. The flow entry 1 in the flow table of the second access layer switch 34B includes the destination address, namely, the IP address of the virtual machine 3. Besides, the flow entry 1 described above is to assign the virtual machine 3 as the destination of packet transmission. Thereby, the packets originally for the second router 36B of the second domain 21 will be forwarded to the port of the virtual machine 3, so that the virtual machine 3 can receives the packets of the second virtual machine 4 via a shorter path instead of detouring via the first domain 20.

The IP address of the virtual machine 3 belongs to the first domain. Hence, when it is migrated to the second domain and communicates with outside, according to the TCP/IP standard, the virtual machine 3 needs to know the gateway of its domain, namely, the first domain. When the virtual machine 3 communicates to the outside, it will first send the ARP to request the AMC address of the gateway of the first domain and generate a broadcast packet of ether-type:0806. The second controller 33B will trigger its forward module to use the flow entry 2 for helping the virtual machine 3 acquire the MAC address of the gateway of the first router 36A in the first domain 20. The virtual machine 3 does not communicate with the other machines having different domains until it acquires the gateway address.

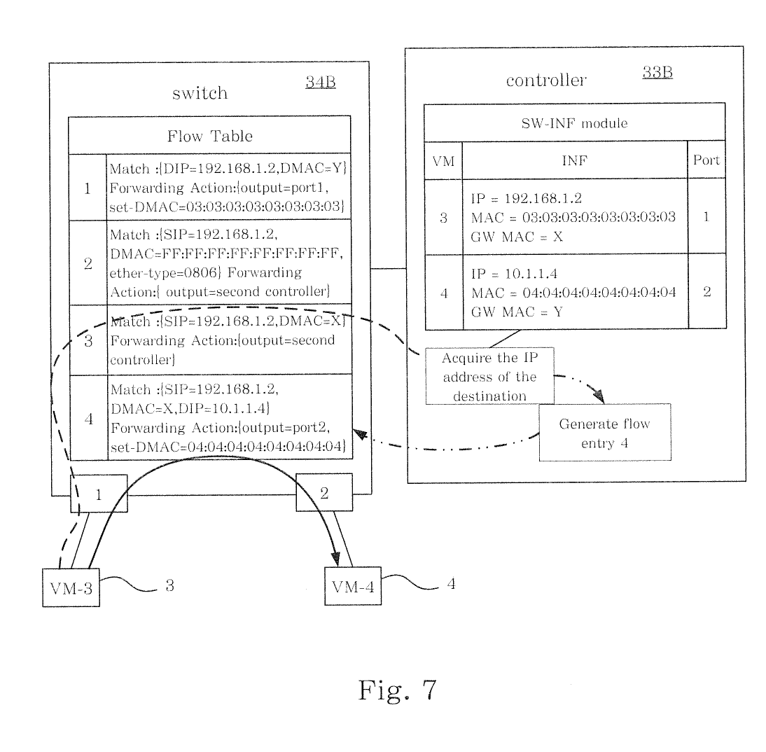

After the virtual machine 3 acquires the MAC address of the gateway of the first router 36A, the destination IP address of the packets the virtual machine 3 sends is the one of the second virtual machine 4, also located in the second domain, and thus complying with the flow entry 3. The flow entry 3 assigns the packets transmitted by the virtual machine 3 to be forwarded to the second controller 33B. In other words, when the IP address of the source of a packet belongs to the virtual machine 3, the packet will be forwarded to the second controller 33B of the second domain 21 for processing, shown as the dashed line in FIG. 7.

The information table of the second controller 33B records the information, including the IP address, the MAC address, the gateway address, and the connected ports, of all the virtual machines connected with it. Please refer to the chain line shown in FIG. 7. Thereby, when the second controller 33B receives the packet, it extracts the destination IP address (DIP) from the packet and uses it as the keyword for searching in the information table of the second controller 33B. Then the MAC address of the destination and the port connected with the second access layer switch 34B will be given. Then the controller generates a flow entry 4 according to the acquired information and writes the flow entry 4 to the flow table of the second access layer switch 34B.

Finally, please refer to solid line in FIG. 7. According to the definition of the flow entry 4 described above for the transmission path, the packet originally for the first domain 20 is modified directly to the destination MAC address of the second virtual machine 4 and forwarded to the connected port.

According to the above process, the first packet of the second virtual machine 4 transmitted by the virtual machine 3 is forwarded to the second controller 33B for processing. Afterwards, when the packet reaches the second access layer switch 34B, it is not necessary to forward the packet to the second controller 33B for processing because the flow entry 4 can be compared successfully. In other words, the flow entry 3 with the lower priority is neglected.

Furthermore, there are four flow entries in the flow table of the second access layer switch 34B, including the flow entry 1, the flow entry 2, the flow entry 3, and the flow entry 4. In particular, the priority of the flow entry 4 is higher than that of the flow entry 3. When the virtual machine 3 submits a packet to the virtual machine 4 of the second domain, only the flow entry 4 will be compared at last. On the other hand, the reverse path, namely, when the virtual machine 4 of the second domain submits a packet to the virtual machine 3, only the flow entry I will be compared. Thereby, the problem of triangle routing is improved effectively.

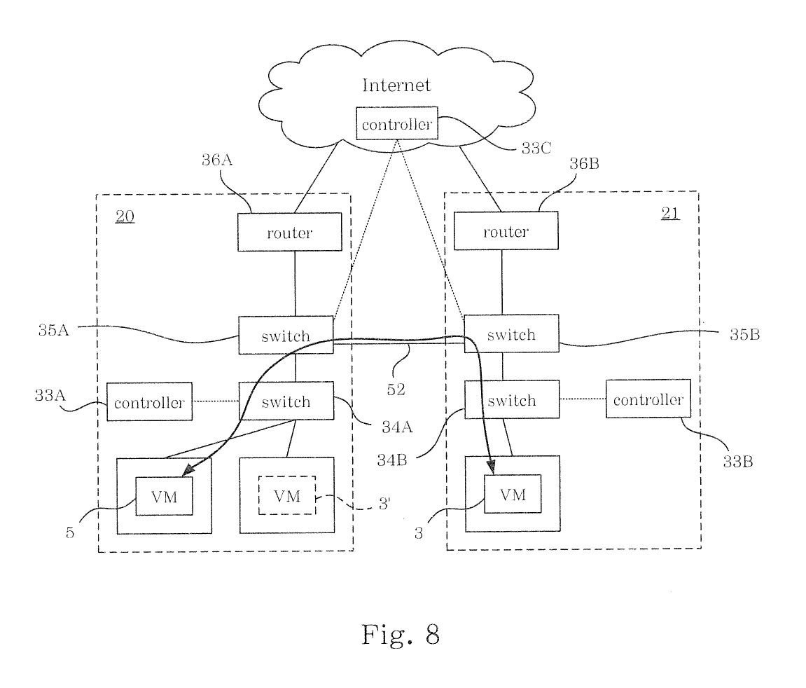

If the migrated virtual machine 3 is to communicate with another virtual machine 5 in the first domain 20 where it is located originally, please refer to FIG. 8. The transmission path of the packet from the virtual machine 5 includes, in order, the first access layer switch 34A of the Layer 2, the first aggregation layer switch 35A, the tunnel 52, the second aggregation layer switch 35B, and the second access layer switch 34B. Given the configuration, after the central controller 33C and the area controllers 33A, 33B load the forward module, the flow entries are generated automatically for the switches and then the communication is established automatically. In addition, when a great number of virtual machines are to be migrated, the flow entries can be installed automatically in the SDN switch in advance and are the same as the previous embodiment. Thereby, the efficiency of the Layer 2 broadcast domain will not deteriorate. The central controller is responsible for maintaining the tunnel setup information as well as managing the aggregation layer switches of various domains.

If a machine in the domain excluding the first and second domains is to communicate with the migrated virtual machine, because the IP address of the virtual machine is not changed, by looking up the traditional routing table in the Internet, the optimal path is from the border router of the first domain, via the first aggregation layer switch as in the previous embodiment, the tunnel, the second aggregation layer switch, and the second access layer switch, and to the destination. The design of the flow entries is identical to that of the previous embodiment.

To SUM up, the present invention discloses in detail a method of virtual machine migration using SDN, which uses the protocol of the SDN technology. When a virtual machine is migrated across domains, the local controller will be notified rapidly for submitting the information of the virtual machine to the switch in advance. Thereby, without modifying the network configuration, the migrated virtual machine can provide service continuously; the optimal routing is achieved and thus improving the problem of triangle routing effectively. By using the present invention, when cloud data centers are using a great deal of virtual technologies, they can migrate virtual machines for solving the problems of overload of physical servers, remote backup, resource allocation, and load balance. Hence, the present invention truly provides a method of virtual machine migration with full utility and economic values.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A method of virtual machine migration using software defined networking, applied while migrating a virtual machine of a first host operating originally in a first domain to a second domain, comprising steps of:
said virtual machine or said first host providing a first migration notice to a first controller of said first domain, said virtual machine or a second host also provide a second migration notice to a second controller of said second domain, and said first migration notice and said second migration notice comprising at least the IP address, the MAC address, and the gateway address of said virtual machine, respectively; and
said second controller writing a flow entry to a switch of said second domain for forwarding a packet with the destination of said virtual machine and passing through a router of said second domain to the connected port of said second domain to which said virtual machine is migrating, and said packet with said virtual machine as the source forwarded to said second controller for processing.

2. The method of virtual machine migration using software defined networking of claim 1, wherein the formats of said packet include the source MAC address (S-MAC), the destination MAC address (D-MAC), the source IP address (SIP), the destination IP address (DIP), the TCP source port (TCP sport), and the PCT destination port (TCP dport).

3. The method of virtual machine migration using software defined networking of claim 1, wherein said switch is a software defined networking switch.

4. The method of virtual machine migration using software defined networking of claim 1, wherein said flow entry is written to the flow table of said switch.

5. The method of virtual machine migration using software defined networking of claim 1, wherein said flow entry includes a flow entry 1 and a flow entry 3; said flow entry 1 assigns said virtual machine as the destination of said packet: and said flow entry 3 assigns said packet transmitted by said virtual machine to be forwarded to said controller.

6. The method of virtual machine migration using software defined networking of claim 5, wherein said flow entry further includes a flow entry 2 used for helping said virtual machine acquire the MAC address of the gateway of the router in said first domain.

7. The method of virtual machine migration using software defined networking of claim 5, wherein said flow entry further includes a flow entry 4 used for modifying directly the destination of said packet from the gateway of said first domain to the destination MAC address of a second virtual machine of the destination and forwarding to the connected port.

8. The method of virtual machine migration using software defined networking of claim 7, wherein the priority of said flow entry 4 is higher than that of said flow entry 3.

9. The method of virtual machine migration using software defined networking of claim 1, herein said switch is an access layer switch.
